(19) United States
(12) Patent Application Publication
(10) Pub. No.: US 2002/0014389 A1
(43) Pub. Date: Feb. 7, 2002

(54) Single relay operated coin escrow apparatus for coin operated equipment

(76) Inventor: Peter L. Bach, Dale City, CA (US)

Correspondence Address: JAMES G. O'NEILL, SUITE K-105, 3151 AIRWAY AVENUE, COSTA MESA, CA, 92626, US

(21) Appl. No.: 09/874,157

(22) Filed: Jun. 4, 2001

Related U.S. Application Data
(60) Provisional application No. 60/204,985, filed on May 17, 2000.

(51) Int. Cl. G07F 5/10; H04M 17/00

(52) U.S. Cl. 194/221; 194/346; 379/143

(57) ABSTRACT

A low-cost, single solenoid operated relay for a coin escrow assembly used in coin operated equipment. The single solenoid moves a forked electromagnet secured thereto to operate a selector card having a magnet held therein to bias between the collect and refund sides of a hopper in the coin escrow assembly, without the need for complex and expensive electronic circuitry.

### CROSS-REFERENCE TO RELATED APPLICATION

This application is a continuation of pending provisional application serial No. 60/204,985 filed May 15, 2000.

### BACKGROUND OF THE INVENTION

1. Field of the Invention

This invention relates generally to coin operated equipment, and more particularly, to a single solenoid operated relay for an escrow apparatus that holds coins until a determination is made whether the coins should be returned to the user of the equipment, or to a coin collection area.

2. Description of Related Art

Coin escrow apparatus are typically used in equipment operated by coins wherein the coins will either be returned to the user or will be sent to a coin collection area or box upon actuation of the equipment. Coin escrow apparatus typically consist of a coin hopper and an electrically operated relay to activate the apparatus. A well known and typical example is the use of an escrow assembly for pay telephones. In a pay telephone, after coins are inserted, they pass through detection means and then travel to an escrow assembly. If the telephone call goes through, the coins are moved to a coin box. If the telephone call does not go through, the coins are then returned to a coin return.

Coin hoppers generally include two separate paths for the coins to follow from the escrow area. The hoppers include two movable doors or flaps, with one door controlling one path, and the other flap controlling the second path. Accordingly, if coins are to be returned to the user, the return door or flap is opened and directs the coins along a return path. If the coins are to go to the coin box, then the coin box door or flap is opened and the coins are directed to a coin box path.

As the cost of telephone calls have increased over the years, the average amount held in escrow and either collected or refunded has increased. Furthermore, much of today's telephone equipment includes electronic components and/or computer chips operated by telephone line power. Nearly all of the approximately 2.5 million paystations used in North America today utilize a relay of a clapper-type design, dating from the 1960's. These pay station relays are mostly designed for a 48 volt application. Inherent in all of these 48 volt relays are both a coin present switch, or “flag”, and a series of contact switches designed to direct current through either a bobbin or resistor, depending upon whether the relay is opened or closed. Additionally, a magnetic selector card and a forked electromagnet are used in tandem to “bias” the device to either collect or refund coins from the hopper, as determined by the polarity of the power supply from the electronic (later computer) chassis. Computer and/or coin line parameters have until recently placed many restrictions on the relay operation, including that they maintain a cycle time of approximately 600 milliseconds (see Attachment “A”). Consequently, the classic relay is relatively costly and sensitive.

Some modern relays use two solenoids, a series of diodes and a complicated mechanical linkage system between the relay and the hopper, if not a unique hopper altogether. Known escrow apparatus also use extensive circuitry and timing controls to operate the two solenoids in the relay. Recent software innovations enable the escrow apparatus to be operated without use of any flag switch signal or timing signal, thereby simplifying their design.

There, therefore, exists a need in the escrow apparatus art for an improved and simplified relay, having a single solenoid, which is more efficient and reliable, and less costly to manufacture, operate and repair.

### SUMMARY OF THE INVENTION

It is, therefore, a general object of the present invention to provide an improved and simplified relay for a coin escrow device. It is a particular object of the present invention to provide an improved relay for a coin escrow device that operates more easily, quickly and smoothly. It is a further particular object of the present invention to provide an improved relay for a coin escrow device, which relay utilizes a single solenoid. It is yet another particular object of the present invention to provide an improved relay for a coin escrow device having a single solenoid that is operated to open and close coin path doors in a hopper. And, it is still another particular object of the present invention to provide an improved single solenoid operated relay for a coin escrow, which relay operates a novel actuator bracket to quickly open and close a pair of flaps in a hopper.

These and other objects and advantages of the present invention are achieved by providing a relay for use in coin operated equipment, which relay operates a pair of movable flaps in a hopper. The relay utilizes a single solenoid to operate a novel actuator bracket to drive a selector card that selectively moves one of the flaps in the hopper.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a front elevational view of one embodiment of a single solenoid operated relay of the present invention, attached to a hopper;

FIG. 2 is a side elevational view of FIG. 1;

FIG. 3 is a side elevational view of the relay, removed from the hopper; and

FIG. 4 is an elevational view of the relay of FIG. 3, looking toward the modified selector card.

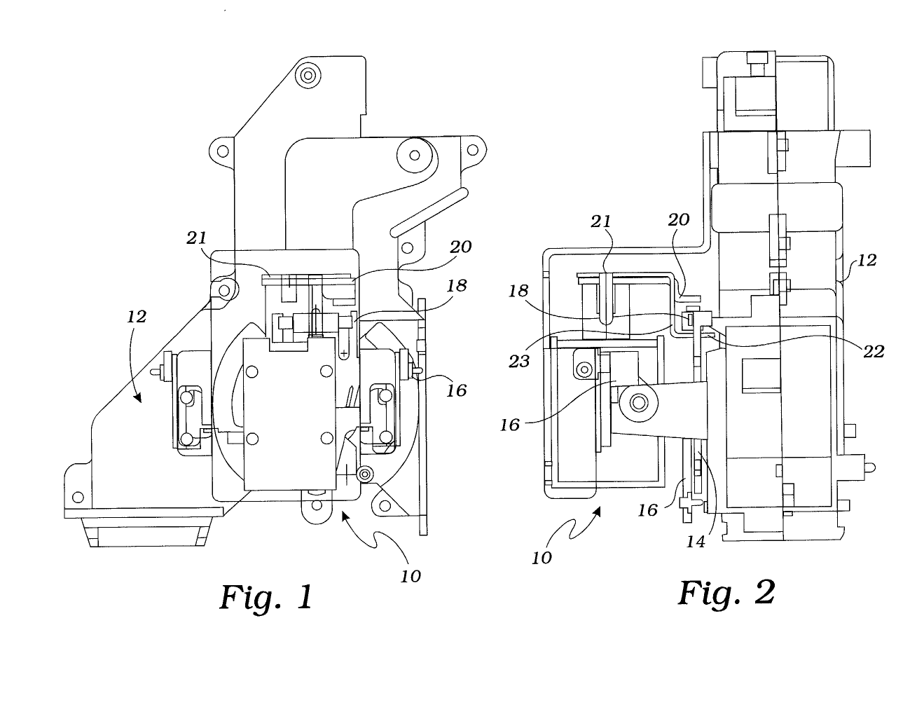

### DETAILED DESCRIPTION OF THE PREFERRED EMBODIMENT

The following description is provided to enable any person skilled in the art to make and use the invention, and sets forth the best modes contemplated by the inventor of carrying out his invention. Various modifications, however, will remain readily apparent to those skilled in the art, since the generic principles of the present invention have been defined herein, specifically to provide for an improved and simplified single solenoid actuated relay 10 for a coin escrow hopper device. The relay 10 easily and quickly controls the opening and closing of flap doors in a hopper, such as those used in coin operated equipment.

Turning now to the drawings, there shown is an embodiment of the single solenoid relay 10 of the present invention secured to a known hopper device 12 to operate doors or flaps therein. This single solenoid relay 10 has a modified selector card 14, a unique bracket 16, a selector card permanent magnet 18 held at an upper end thereof, adjacent a forked electromagnet 20, made from zinc covered steel, or other material that will be magnetized when electrical energy is applied thereto. The forked electromagnet 20, as explained more fully below, cooperates with the permanent magnet 18 in the selector card 14 move the selector card and therefore, bias the hopper's direction of operation. The single solenoid relay 10 is preferably of the single plunger type, and is coupled to the unique bracket 16 to drive the selector card 14 against the hopper 12.

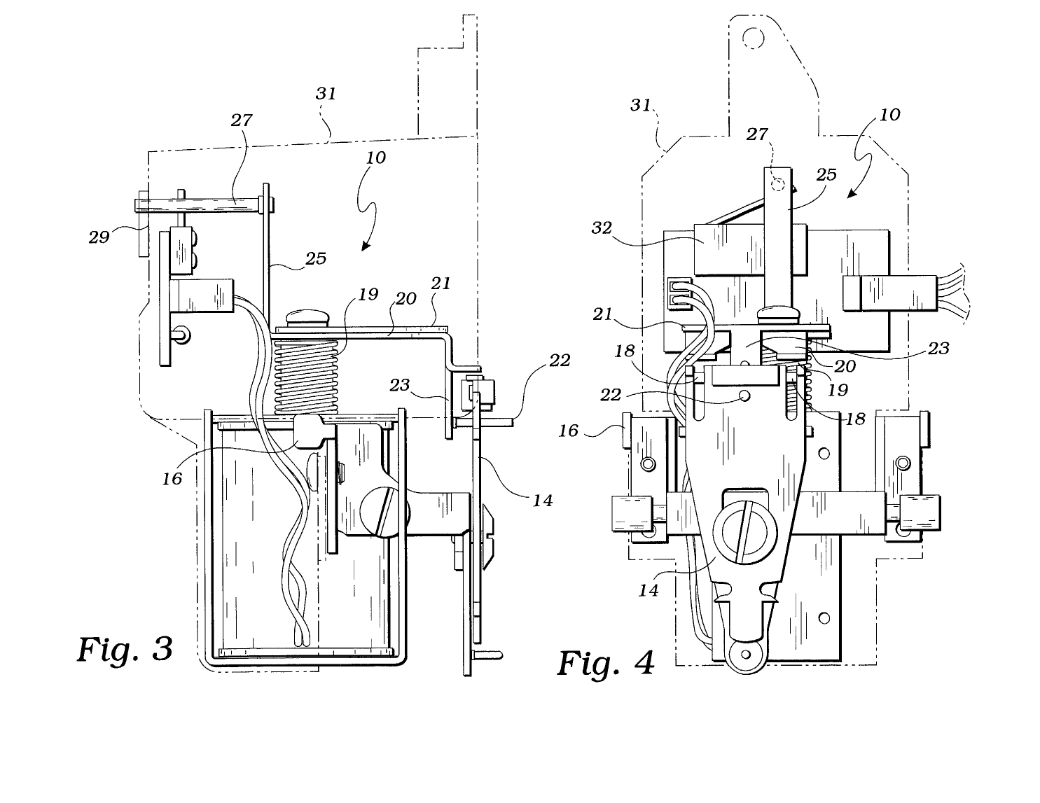

As on a standard relay, the bias of the relay 10 is determined by the polarity of the forked electromagnet 20, which is in turn determined by the polarity of the bobbin, which is ultimately determined by the polarity of the chassis signal. However, unlike a standard relay, the forked electromagnet 20 is connected to and magnetized through a moving solenoid plunger 19 (see FIG. 3). This forked electromagnet 20 is directly fastened to the solenoid plunger 19, as by means of a holding element, such as a screw, and a stainless steel plate 21 having a finger 23 formed thereon. Electromagnet elements used in known relays are mounted stationary in the bobbin. However, the mounting of the forked electromagnet 20 to the solenoid plunger 19 allows the forked electromagnet to move vertically with the selector card 14. Therefore, the relay 10 of the present invention is: (1) significantly less costly to produce; (2) contains many fewer components than any other designs; and, (3) far less susceptible to damage from mishandling than known designs.

The modified selector card 14 of the present invention has a circular hole formed in a top portion thereof adjacent the permanent magnet 18, and a pin 22, secured to the finger 23 of stainless steel plate 21, is inserted in this hole. This allows the selector card 14 to be maintained in a selected position whereby the forked electromagnet 20, when moved by the solenoid plunger 19 pushes or pulls the oppositely polarized ends of the permanent magnet 18. This movement of the forked electromagnet 20 precisely operates the selector card 14 in a desired direction, and, therefore, opens a selected flap or door in the hopper 12.

As shown in FIGS. 3 and 4, the single solenoid relay 10 of the present invention may also include an upwardly extending arm or leg 25 secured to or formed on the forked electromagnet 20. A pin 27 is attached or secured to this arm or leg 25 and passes through or is captured in a slot 29 formed in a cover or housing 31. The pin may be used to actuate a switch 32, upon actuation of the solenoid plunger 19, or may be used to manually operate the plunger 19 and selector card 14, as by means of a small device inserted into the slot 29 and pressed against pin 27.

It, therefore, can be seen that the single solenoid actuated relay of the present invention provides for a novel device, which actuates a known hopper apparatus in which flaps are positively moved between open and closed positions by the actuation of the single solenoid when it moves a plunger together with an attached forked electromagnet to thereby selectively move a selector card.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. An improved solenoid relay for a coin escrow device used in a coin operated system, comprising:
a single solenoid actuating means connected to an actuator bracket that drives a selector card against the coin escrow device; and
the single solenoid actuating means also including; a selector card magnet held in the selector card and a forked electromagnet a plunger held in the single solenoid actuator to bias the direction of operation of the coin escrow device.

2. The improved solenoid relay for a coin escrow device of claim 1, further including a stainless steel holding element securing the forked electromagnet to a plunger held in the single solenoid actuating means.

3. The improved solenoid relay for a coin escrow device of claim 2 wherein the stainless steel holding element includes an arm extending therefrom and a finger is secured to the arm and passes through an opening formed in the selector card.

4. The improved solenoid relay for a coin escrow device of claim 3 wherein the forked electromagnet includes an arm extending therefrom and a pin is attached to the arm.

5. An improved solenoid relay for a coin escrow device used in a coin operated system, comprising:
a single solenoid actuator connected to an actuator bracket that drives a selector card against the coin escrow device; and
the single solenoid actuator being secured to a forked electromagnet by a stainless steel holding element and cooperating with a selector card magnet held in the selector card to bias the direction of operation of the coin escrow device.

6. The improved solenoid relay for a coin escrow device of claim 5 wherein the stainless steel holding element includes an arm extending therefrom and a finger is secured to the arm and passes through an opening formed in the selector card, away from the selector card magnet.

7. The improved solenoid relay for a coin escrow device of claim 6 wherein the forked electromagnet includes an arm extending therefrom and a pin is attached to the arm and extends through an opening formed in a housing for the improved solenoid relay.

8. An improved solenoid relay for a coin escrow device used in a coin operated system, comprising:
a single solenoid actuator having a plunger;
the single solenoid actuator being connected to an actuator bracket that drives a selector card against the coin escrow device;
a forked electromagnet secured to the plunger by a stainless steel holding element and cooperating with a selector card magnet held in the selector card to bias the direction of operation of the coin escrow device;
the stainless steel holding element including an arm extending therefrom and a finger secured to the arm and passing through an opening formed in the selector card, away from the selector card magnet; and
the forked electromagnet having an arm extending therefrom with a pin attached to the arm and extending through an opening formed in a housing for the improved solenoid relay.
